(19) United States
(12) Patent Application Publication
(10) Pub. No.: US 2019/0121938 A1
(43) Pub. Date: Apr. 25, 2019

(54) TRIE-BASED POLYPLOID PHASING

(71) Applicant: INTERNATIONAL BUSINESS MACHINES CORPORATION, Armonk, NY (US)

(72) Inventors: Laxmi Parida, Mohegan Lake, NY (US); Filippo Utro, Pleasantville, NY (US)

(21) Appl. No.: 15/793,394

(22) Filed: Oct. 25, 2017

(51) Int. Cl. G06F 19/22; G06F 19/18

(52) U.S. Cl. CPC G06F 19/22; G06F 19/18

(57) ABSTRACT

A computer-implemented method, computer program product, and computer processing system are provided for phasing polyploids. The method includes receiving, by a processor, a n×m matrix including a set of n rows and a set of m columns. Each of the n rows represents a respective one of n samples. Each of the m columns represents a respective one of m SNPs for two or more sample organisms. The method further includes representing, by the processor, each allele in the m SNPs as a binary number. The method also includes phasing, by the processor, the n samples to determine a haplotype of a parent of the two or more sample organisms. The phasing is performed using a trie to process a distribution of alleles in the n-samples that includes homozygous alleles and heterozygous alleles.

### BACKGROUND

### Technical Field

The present invention relates generally to polyploid phasing and, in particular, to trie-based polyploid phasing.

### Description of the Related Art

Organisms typically possess multiple copies of the same chromosome. Many species in nature are polyploid, which means the species has 2 or more copies of the same chromosomes. Examples of polyploid species include triploids (e.g., seedless watermelons), tetraploids (e.g., Salmonida fish), pentaploids (e.g., Kenai Birch), hexaploid (e.g., wheat, kiwifruit), octaploids or octoploids (e.g., Acipenser, dahlias), decaploids (e.g., certain strawberries), and dodecaploids (e.g., Celosia argentea, Spartina angilica, and Xenopus ruwenzoriensis). Polyploidy is common in plants and is also observed in some animals. Moreover, some human tissue can be polyploidy (e.g., human muscle tissues, human liver tissues, and human bone marrow).

However, genotyping methods cannot separate these different copies of the same chromosome. Hence, there is a need for an approach for phasing polyploids that is capable of separating these different copies of the same chromosome.

### SUMMARY

According to another aspect of the present invention, a computer-implemented method is provided for phasing polyploids. The method includes receiving, by a processor, a n×m matrix including a set of n rows and a set of m columns. Each of the n rows represents a respective one of n samples. Each of the m columns represents a respective one of m SNPs for two or more sample organisms. The method further includes representing, by the processor, each allele in the m SNPs as a binary number. The method also includes phasing, by the processor, the n samples to determine a haplotype of a parent of the two or more sample organisms. The phasing is performed using a trie to process a distribution of alleles in the n-samples that includes homozygous alleles and heterozygous alleles.

According to another aspect of the present invention, a computer program product is provided for phasing polyploids. The computer program product includes a non-transitory computer readable storage medium having program instructions embodied therewith. The program instructions are executable by a computer to cause the computer to perform a method. The method includes receiving, by a processor, a n×m matrix including a set of n rows and a set of m columns. Each of the n rows represents a respective one of n samples. Each of the m columns represents a respective one of m SNPs for two or more sample organisms. The method further includes representing, by the processor, each allele in the m SNPs as a binary number. The method also includes phasing, by the processor, the n samples to determine a haplotype of a parent of the two or more sample organisms. The phasing is performed using a trie to process a distribution of alleles in the n-samples that includes homozygous alleles and heterozygous alleles.

According to yet another aspect of the present invention, a computer processing system is provided for phasing polyploids. The computer processing system includes a processor. The processor is configured to receive a n×m matrix comprising a set of n rows and a set of m columns. Each of the n rows represents a respective one of n samples. Each of the m columns represents a respective one of m SNPs for two or more sample organisms. The processor is further configured to represent each allele in the m SNPs as a binary number. The processor is also configured to phase the n samples to determine a haplotype of a parent of the two or more sample organisms. The n samples are phased using a trie to process a distribution of alleles in the n-samples that includes homozygous alleles and heterozygous alleles.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 shows an exemplary processing system to which the present invention may be applied, in accordance with an embodiment of the present invention;

FIG. 2 shows an exemplary input genotype n×m matrix to which the present invention can be applied, in accordance with an embodiment of the present invention;

FIG. 3 shows an exemplary trie [symbol] , in accordance with an embodiment of the present invention;

FIG. 4 shows exemplary list labels for the trie of FIG. 3, in accordance with an embodiment of the present invention;

FIG. 5 shows an exemplary method for generating a trie for polyploid phasing, in accordance with an embodiment of the present invention;

FIG. 6 shows a method for a greedy min set cover, in accordance with an embodiment of the present invention;

FIG. 7 shows an exemplary method to eliminate singletons from a matrix, in accordance with an embodiment of the present invention;

FIG. 8 shows an exemplary method to reduce gaps between siblings, in accordance with an embodiment of the present invention;

FIG. 9 shows an exemplary backtracking method, in accordance with an embodiment of the present invention;

FIG. 10 shows an exemplary trie-shaking method, in accordance with an embodiment of the present invention;

FIG. 11 shows an exemplary trie to which the method of FIG. 10 can be applied, in accordance with an embodiment of the present invention;

FIG. 12 shows exemplary leaf labels being evaluated under certain criteria, in accordance with an embodiment of the present invention;

FIG. 13 shows exemplary prune and attach operations, in accordance with an embodiment of the present invention;

FIG. 14 shows an exemplary threaded trie resulting from a trie shake process, in accordance with an embodiment of the present invention;

FIG. 15 shows another exemplary method for phasing using a trie, in accordance with an embodiment of the present invention;

FIGS. 16-19 show an exemplary matrix for generating a trie, in accordance with an embodiment of the present invention;

FIG. 20 shows an exemplary method for processing the matrix of FIGS. 16-19, in accordance with an embodiment of the present invention;

FIG. 21 shows an exemplary table, in accordance with an embodiment of the present invention;

FIG. 22 shows another exemplary table, in accordance with an embodiment of the present invention;

FIGS. 23-26 show another exemplary matrix for generating a trie, in accordance with an embodiment of the present invention; and

FIG. 27 shows an exemplary method for processing the matrix of FIGS. 23-26, in accordance with an embodiment of the present invention.

### DETAILED DESCRIPTION

The present invention is directed to trie-based polyploid phasing.

In accordance with one or more embodiments of the present invention, methods, systems and computer program products are provided for trie-based polyploid phasing. A polyploid is an organism that has two or more copies of the same chromosome. For example, a kiwi is a polyploid that has five copies of a chromosome. In agriculture, certain traits of plants are desired over other traits. For example, a kiwi having a larger size and/or is evenly shaped is desirable over a kiwi that is smaller and/or has an oddly shape. Another example is a seedless fruit such as a seedless watermelon. When certain traits are deemed desirable, determining a particular part (or full) chromosome(s) that the trait is descendent from is required for repeating the trait in future progeny.

The determination of parent chromosomes possessing desired traits is sometimes referred to as “haplotype estimation” or “haplotype phasing”. A haplotype is a group of genes within an organism that was inherited together from a single parent. The word “haplotype” is derived from the word “haploid,” which describes cells with only one set of chromosomes, and from the word “genotype,” which refers to the genetic makeup of an organism. Haplotype phasing, typically, utilizes a process of statistical estimation of a haplotype from genotype data. In one or more embodiments of the present invention, a phasing of polyploids is performed based on a trie to determine haplotypes.

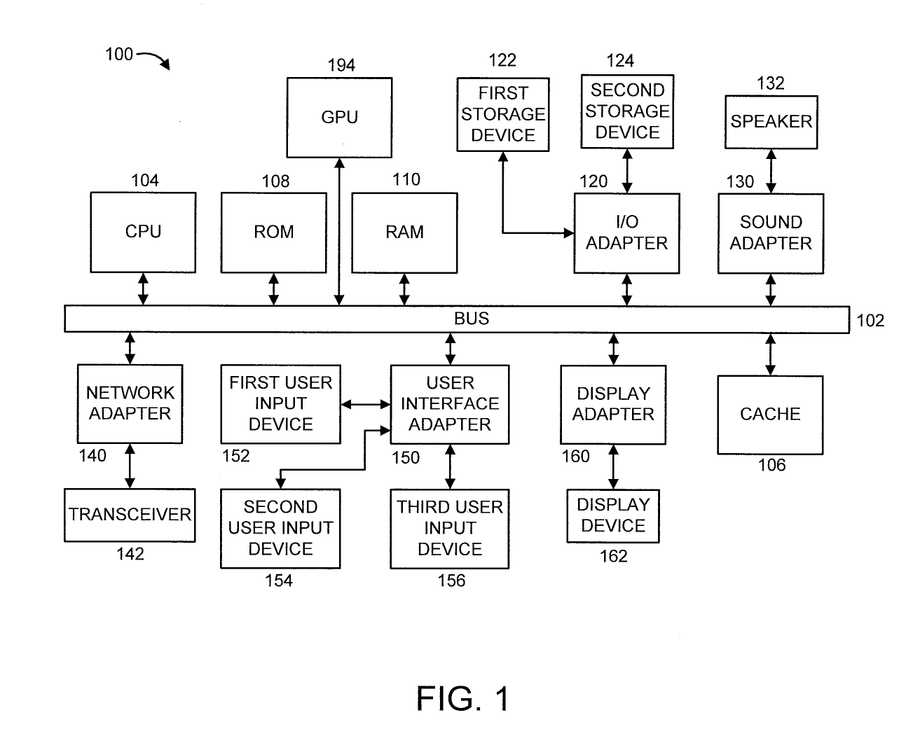

FIG. 1 shows an exemplary processing system 100 to which the invention principles may be applied, in accordance with an embodiment of the present invention. The processing system 100 includes at least one processing element 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102. At least one Graphics Processing Unit (GPU) 194 is operatively coupled to the system bus 102.

The at least one processing element 104 can be, for example, but is not limited to, a processor, a controller, an Application Specific Integrated Circuit (ASIC), and so forth.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present invention provided herein.

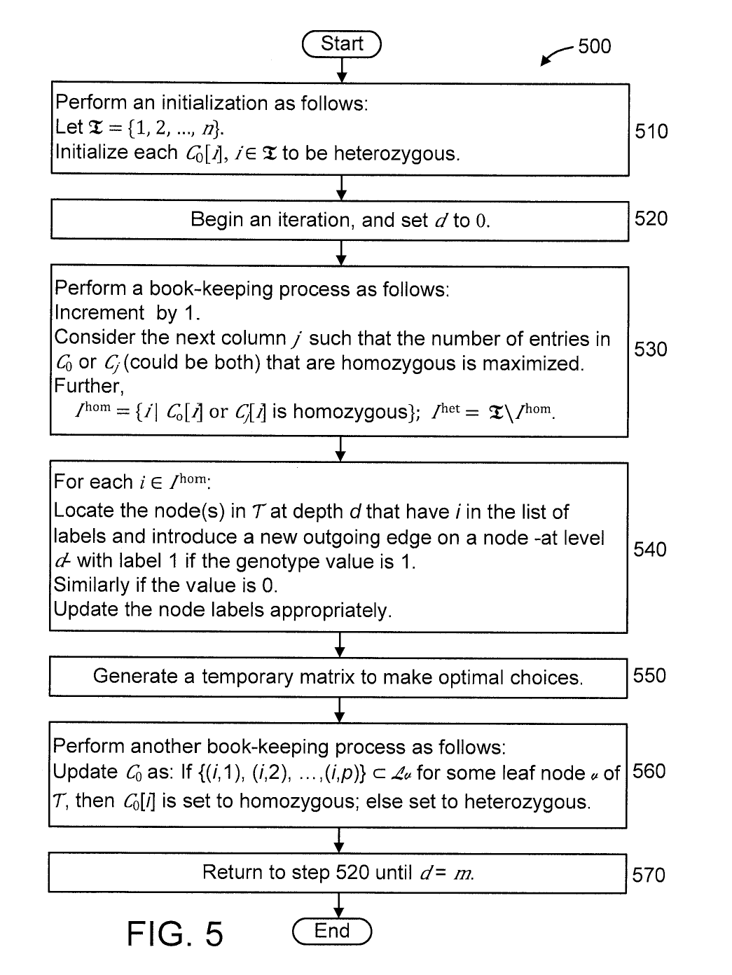

Further, it is to be appreciated that processing system 100 may perform at least part of the methods described herein including, for example, at least part of methods 500, 700, 800, 900, 1000, and 15 of FIGS. 5, 7, 8, 9, 10, and 15, respectively.

A description will now be given regarding various aspects of the present invention, in accordance with one or more embodiments of the present invention.

Without loss of generality, let the minimum allele frequency of each allele be denoted as 1 and the ancestral as 0.

Problem 1. Given n samples as p-ploid genotypes with m SNPs, the task is to phase the n samples, assuming no cross-over in the genomic segment spanning these m markers.

This is a realistic problem setting in genic regions since crossovers in viable offsprings occur mostly in the intergenic regions.

A description will now be given regarding some guiding principles for one or more embodiments of the present invention.

Optimization Problem Model (OPM). The phasing problem is NP-complete, even for diploids [ ]. Let H₁, H₂, . . . , be the haplotypes and let f_{H}_{ᵢ} be the frequency with which haplotype Hᵢ is seen in the phased samples. We define the entropy E as follows:

E=Σᵢf_{H}_{ᵢ}² (1)

The cost function is defined as simultaneously minimizing both the following:

OPM I: the number of haplotypes (h) and

OPM II: the entropy (E).

Usually, bi-allelic SNPs pull a solution configuration towards sharp peaks in the haplotype frequency distributions and minimizing the number of haplotypes is no guarantee for the absence of these artifacts. On the other hand, lowering the entropy in the solution discourages these types of artifacts.

Algorithm Design (AD). We design a greedy algorithm. In one or more embodiments, one or more backtracking heuristics can be applied. The algorithm described in the next section is guided by the following:

AD I (One-Choice): We use the homozygous SNPs in a sample to make the “inevitable” one-choice decisions. Further make these choices as early as possible, both in the iterations and within each iteration, to mitigate error propagation.

AD II (Multiple-Choice): If the multiple options are not equally favorable, based on the cost function, we appropriately order the decision making. Further, for equally favorable multiple options, the implementation makes a random call, that could be different in each run of the algorithm. This randomness is used to generate multiple possible solutions with each run.

A description will now be given of an algorithm outline, in accordance with an embodiment of the present invention.

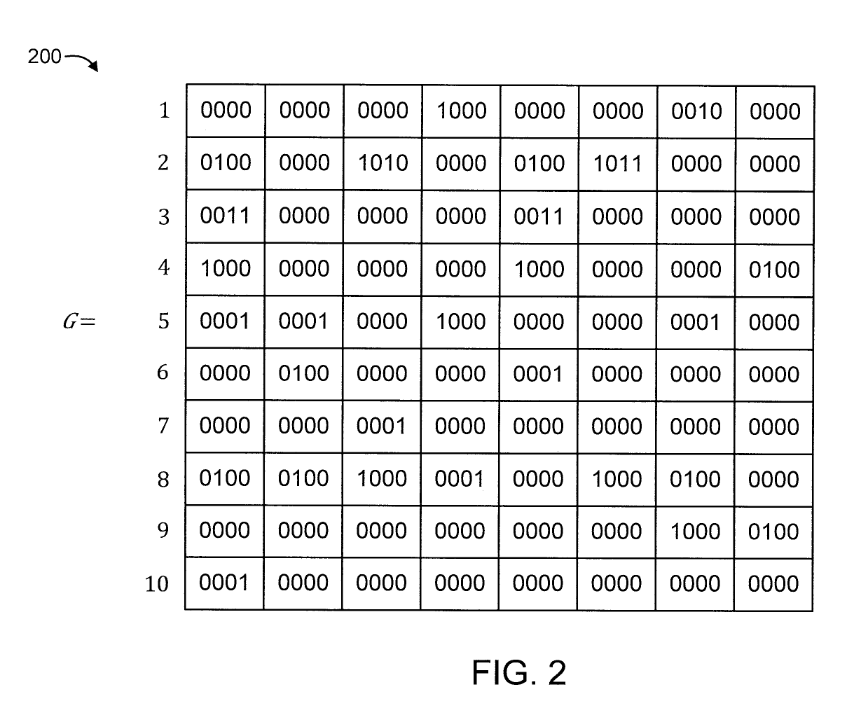

Input: As shown in FIG. 2, the input can be a genotype n×m matrix 200 where the number of SNPs (or columns) is m and the number of samples (or rows) is n. A column Cⱼ, j=1, 2, . . . , m, refers to the alleles in SNP j and Cⱼ[i], 1≤i≤n, refers to the the jth genotype in the ith sample, which is a set of p binary values. Each of these is accessed as G[i][j][k].

Data Structure: Let

U={f(i,k)|1≤i≤n,1≤k≤p}.

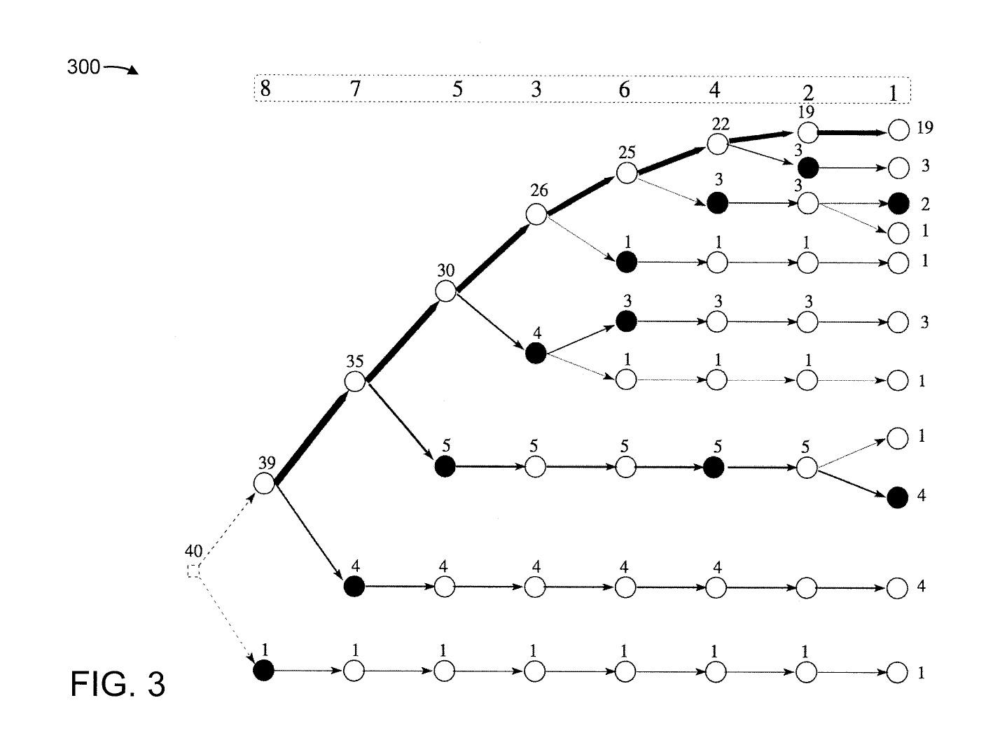

As shown in FIG. 3, a trie [symbol] 300 is initialized with a single node (also the root). Every node v on [symbol] has exactly one incoming edge and at most two outgoing edges, with the following exception: a root has no incoming edge and a leaf has no outgoing edges. If e is an incoming edge from v₁ to v₂ then v₂ is the child of v₁ and v₁ is the parent of v₂. Each node v is labeled with a pair denoted as follows:

(xᵥ, [symbol] ᵥ) where xᵥ∈{0,1} and [symbol] ⊂U

The root node is an exception and in the initialization, the root is assigned the label (Ø, U). The root node is denoted as v₀. xᵥ is called the SNP label of v and [symbol] ᵥ is the list label of v. The depth of a node v is defined as the distance, in term's of edges in the path, from the root v₀. Thus, depth (v₀) is 0. We maintain the following invariance at each iteration d:

$$\begin{matrix}depth ( v ) = d , where v is a leaf node & ( 2 ) \\ {v}_{} = {⋃}_{u is a child of v} {ℒ}_{u} & ( 3 ) \\ U = {⋃}_{v is a leaf} {ℒ}_{v} & ( 4 )\end{matrix}$$

Lemma 1. If h is the number of leaves at depth m in [symbol] , then h is the number of distinct haplotypes for the given instance of Problem 1. Each leaf corresponds to a distinct haplotype and is obtained by reading off the 0/1 label of the nodes in the path from the root node to the leaf.

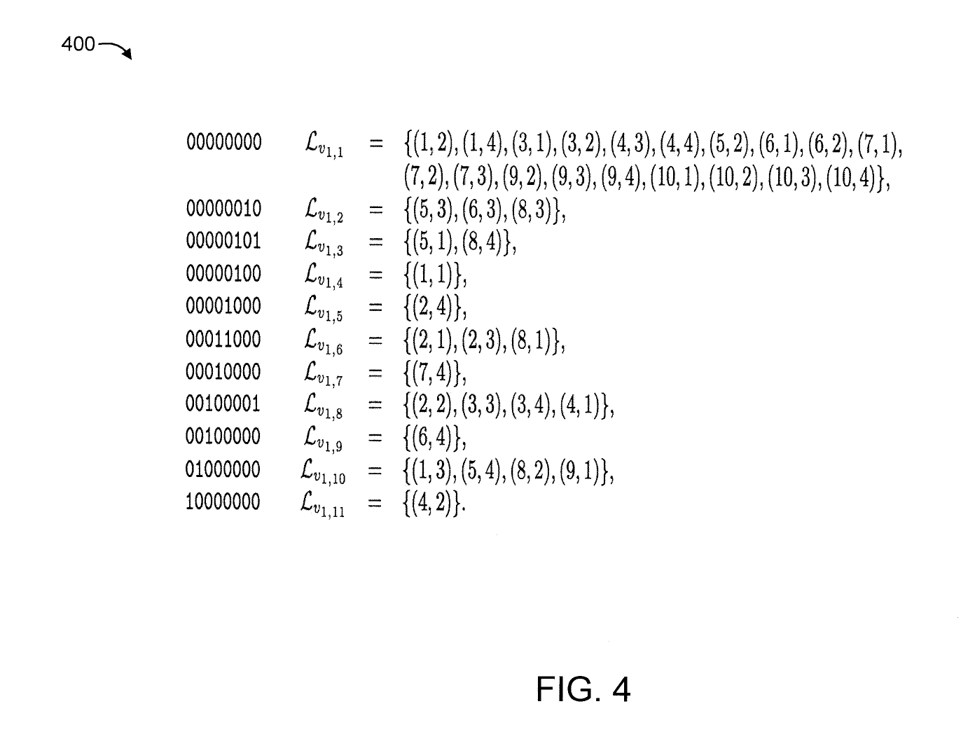

FIG. 4 shows exemplary list labels 400 for the trie 300 of FIG. 3, in accordance with an embodiment of the present invention.

FIG. 5 shows an exemplary method 500 for generating a trie for polyploid phasing, in accordance with an embodiment of the present invention. In an embodiment, the trie generated by method 500 can be trie 300 shown and described with respect to at least FIG. 3. It is to be appreciated that the generation (and optimization) of the trie also results in the performing of polyploid phasing.

At step 510, perform an initialization as follows:

Let [symbol] ={1, 2, . . . , n}. Initialize each C₀[i], i∈ [symbol] to be heterozygous.

At step 520, begin an iteration, and set d to 0.

At step 530, perform a book-keeping process as follows:

### Increment d by 1.

Consider the next column j such that the number of entries in C₀ or Cⱼ (could be both) that are homozygous is maximized. Further,

I^{hom}={i|C₀[i] or Cⱼ[i] is homozygous};I^{het}= [symbol] /I^{hom}

At step 540, (HOM: new nodes induced by i∈I^{hom}; AD I nodes and labels), for each i∈I^{hom}:

Locate the node(s) in [symbol] at depth d that have i in the list of labels and introduce a new outgoing edge on a node—at level d—with label 1 if the genotype value is 1. Similarly if the value is 0. Update the node labels appropriately.

At step 550 (HET: global optimization for AD II nodes and labels), generate a temporary matrix, as shown in the examples, to make the optimal choices.

At step 560, perform another book-keeping process as follows:

Update C₀ as: If {(i, 1), (i, 2), . . . , (i, p)}⊂ [symbol] ᵥ for some leaf node v of [symbol] , then C₀[i] is set to homozygous; else set to heterozygous.

At step 570, return to step 520 until d=m.

A description will now be given regarding a concrete example, in accordance with one or more embodiments of the present invention.

Refer back to FIG. 2 for the example input matrix G and back to FIG. 3 for the trie [symbol] 300 that is constructed. The nodes in the trie 300 are labeled by the column identifier on top and then following vertically down from that column. For example, v_{5,3} refers to the third node from top along the column marked 5. It is labeled by SNP 0 (i.e., hollow circle) and the cardinality of the label set is 4.

Referring back to FIG. 2, an input genotype matrix G (70% homozygous) is provided with n=10 samples and m=8 SNPs and p=4. Referring back to FIG. 3 shows the trie [symbol] 300 constructed by the present invention, in accordance with an embodiment of the present invention. The root is the leftmost rectangular node. Each hollow circle has a SNP label of 0 and a solid circle a SNP label of 1. The columns are considered (left to right) in the order 8, 7, . . . , 2, 1. To avoid clutter we only give the cardinality of the list label of each node, which is also reflected in the thickness the incident in-coming edge on the vertex. The solution has 11 distinct haplotypes corresponding to each of the 11 leaf nodes. The gold solution (simulated data) has 11 haplotypes with 5 unique occurrences; 2 twice, 2 thrice, 1 four times and 1 occurring twenty-one times in G.

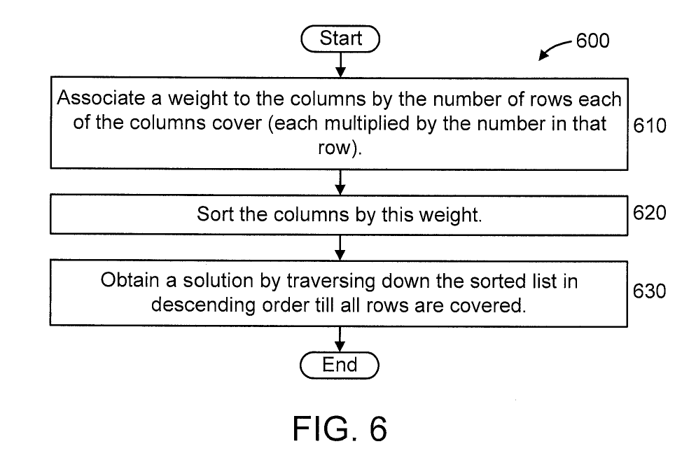

FIG. 6 shows a method for a greedy min set cover, in accordance with an embodiment of the present invention.

At step 610, associate a weight to the columns by the number of rows each of the columns cover (each multiplied by the number in that row).

At step 620, sort the columns by this weight.

At step 630, obtain a solution by traversing down the sorted list in descending order till all rows are covered.

A node is untouchable if and only if all its ancestral nodes are produced by homozygosity. Every other node is touchable.

The priority to fix the matrix, after the 1's have been assigned, can be as follows: (1) eliminate singletons; and (2) reduce gaps between siblings.

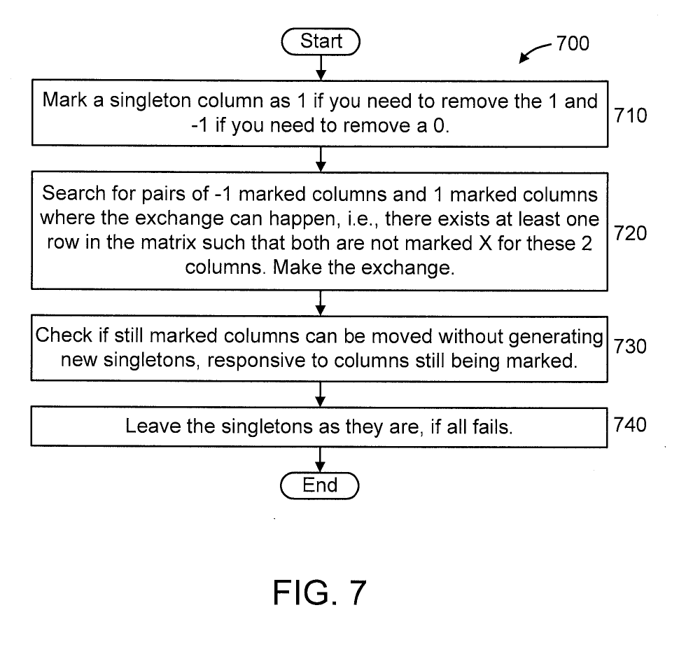

FIG. 7 shows an exemplary method 700 to eliminate singletons from a matrix, in accordance with an embodiment of the present invention.

At step 710, mark a singleton column as 1 if you need to remove the 1 and −1 if you need to remove a 0.

At step 720, search for pairs of −1 marked columns and 1 marked columns where the exchange can happen, i.e., there exists at least one row in the matrix such that both are not marked X for these 2 columns. Make the exchange.

At step 730, check if still marked columns can be moved without generating new singletons, responsive to columns still being marked.

At step 740, leave the singletons as they are, if all fails.

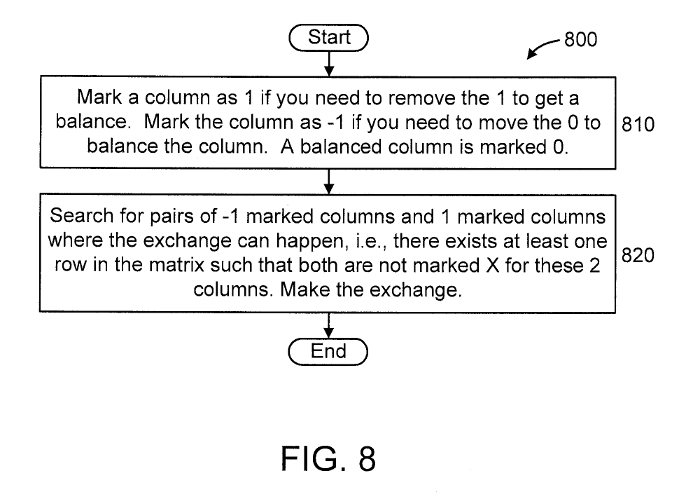

FIG. 8 shows an exemplary method 800 to reduce gaps between siblings, in accordance with an embodiment of the present invention.

At step 810, mark a column as 1 if you need to remove the 1 to get a balance. Mark the column as −1 if you need to move the 0 to balance the column. A balanced column is marked 0.

At step 820, search for pairs of −1 marked columns and 1 marked columns where the exchange can happen, i.e., there exists at least one row in the matrix such that both are not marked X for these 2 columns. Make the exchange.

Heuristic I:

using set cover (explained earlier, see, e.g., FIG. 7).

Heuristic II:

controlling the MAF allele (1's) along each path of the tree or haplotype

Heuristic III (backtracking):

collapse two isomorphic sub-trees (based on satisfying two conditions).

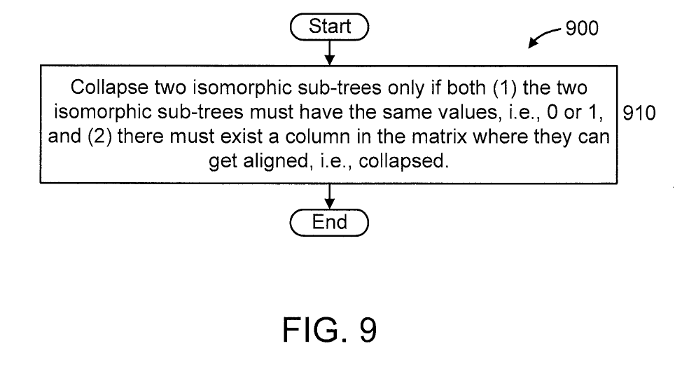

FIG. 9 shows an exemplary backtracking method 900, in accordance with an embodiment of the present invention.

At step 910, collapse two isomorphic sub-trees only if both (1) the two isomorphic sub-trees must have the same values, i.e., 0 or 1, and (2) there must exist a column in the matrix where they can get aligned, i.e., collapsed.

Heuristic IV (Trie-Shaking):

Trie-shake algorithm.

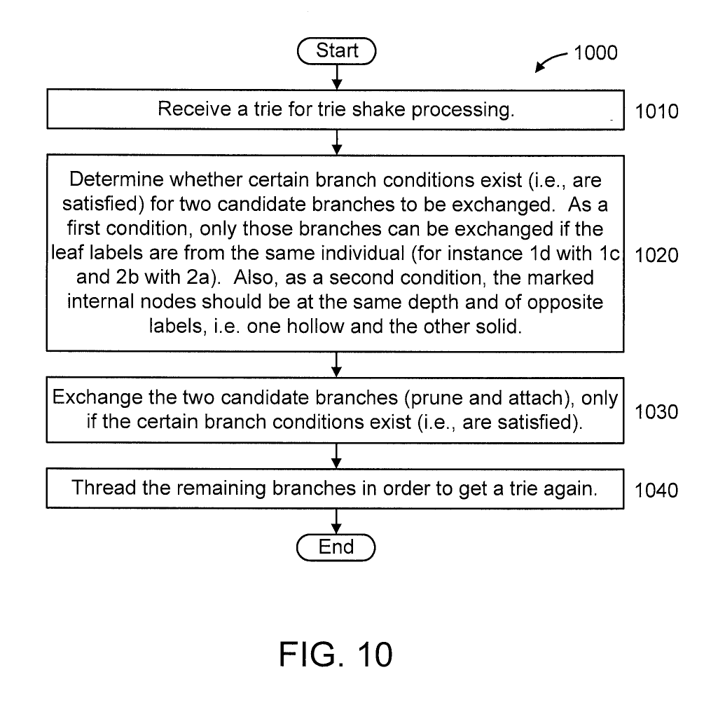

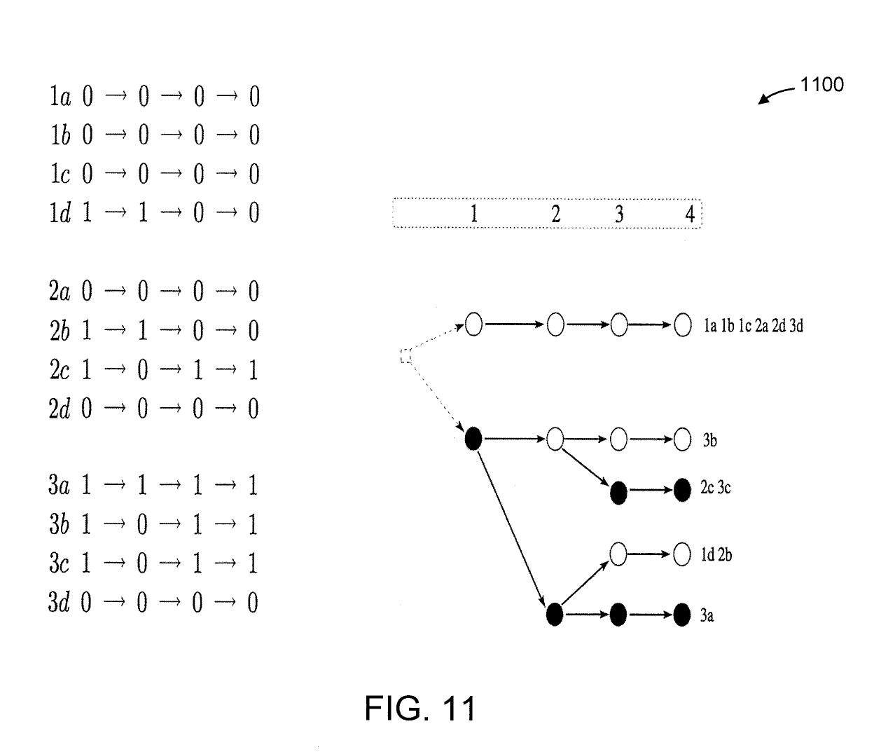

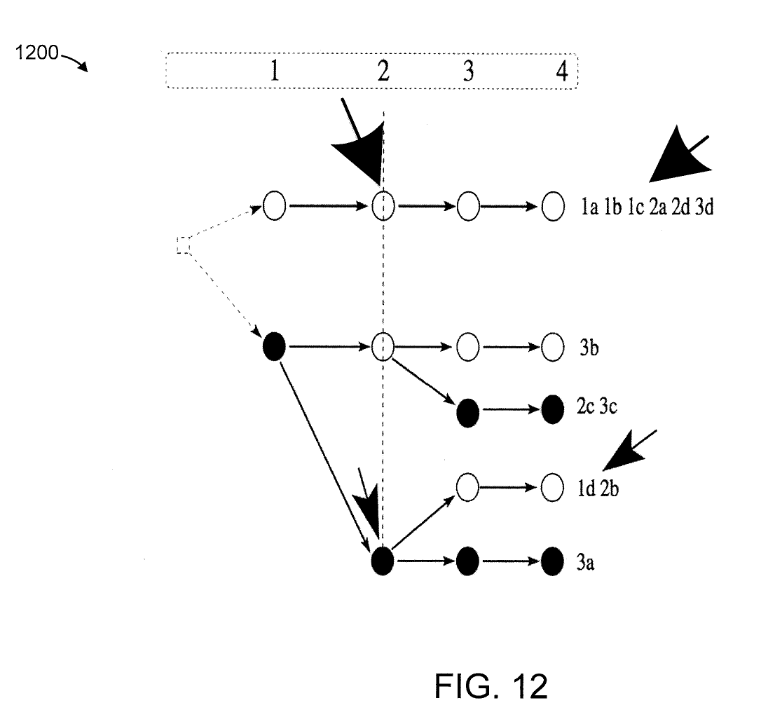

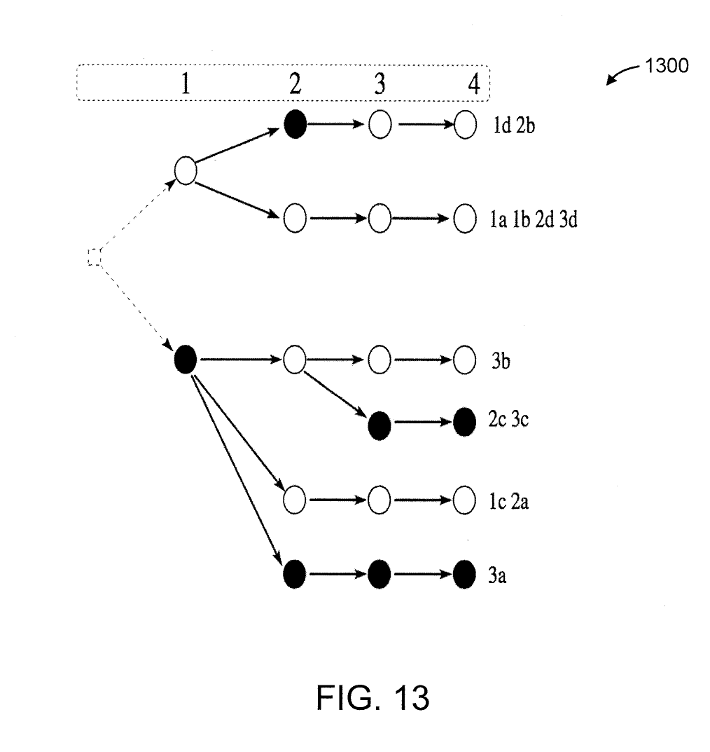

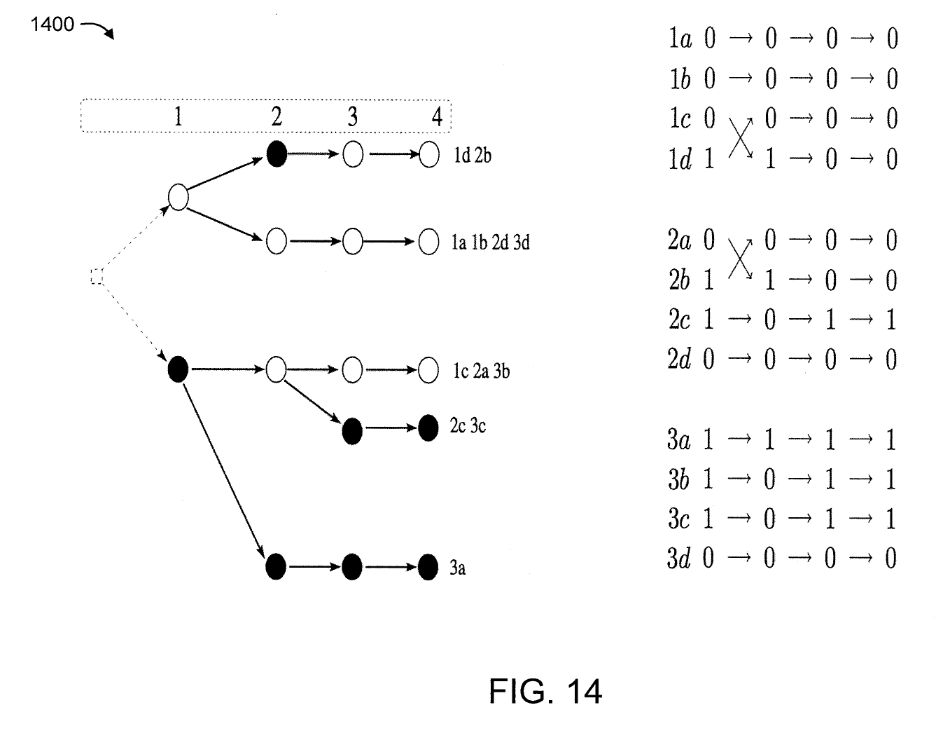

FIG. 10 shows an exemplary trie-shaking method 1000, in accordance with an embodiment of the present invention. FIG. 11 shows an exemplary trie 1100 to which the method 1000 of FIG. 10 can be applied, in accordance with an embodiment of the present invention. FIG. 11 can be considered to relate to step 1010 of method 1000. FIG. 12 shows exemplary leaf labels 1200 being evaluated under certain criteria, in accordance with an embodiment of the present invention. FIG. 12 can be considered to relate to step 1020 of method 1000. FIG. 13 shows exemplary prune and attach operations 1300, in accordance with an embodiment of the present invention. FIG. 13 can be considered to relate to step 1130 of method 1000. FIG. 14 shows an exemplary threaded trie 1400 resulting from a trie shake process, in accordance with an embodiment of the present invention. FIG. 14 can be considered to relate to step 1140 of method 1000.

At step 1010, receive a trie for trie shake processing.

At step 1020, determine whether certain branch conditions exist (i.e., are satisfied) for two candidate branches to be exchanged. That is, as a first condition, only those branches can be exchanged if the leaf labels are from the same individual (for instance 1d with 1c and 2b with 2a). Also, as a second condition, the marked internal nodes should be at the same depth and of opposite labels, i.e. one hollow and the other solid.

At step 1030, exchange the two candidate branches (prune and attach), only if the certain branch conditions exist (i.e., are satisfied).

At step 1040, thread the remaining branches in order to get a trie again.

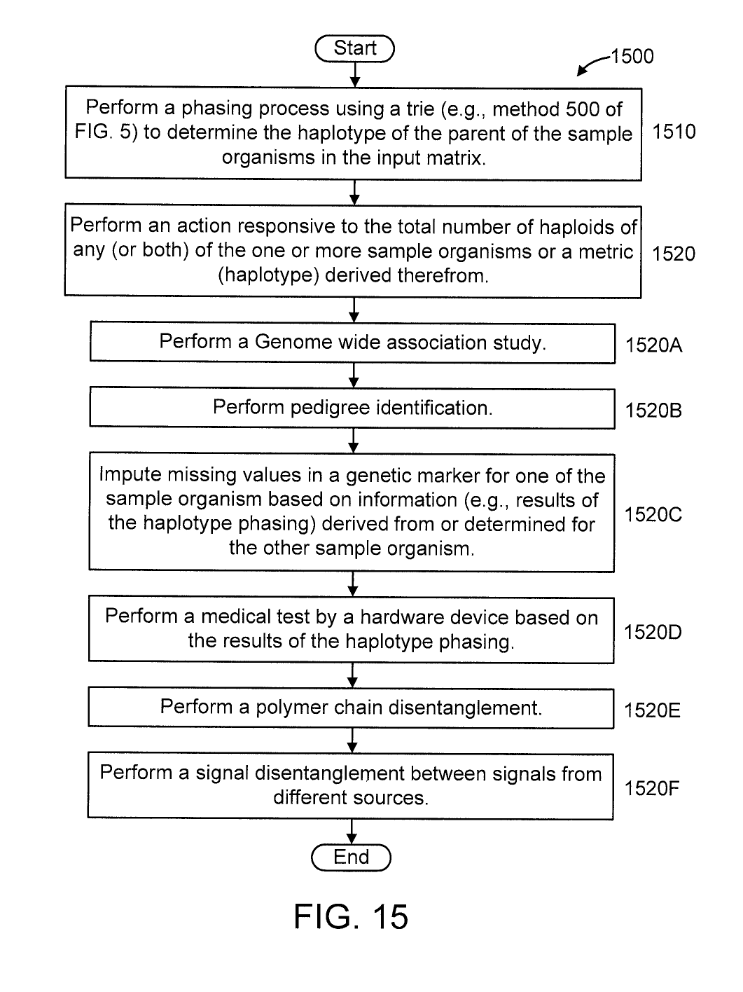

FIG. 15 shows another exemplary method 1500 for phasing using a trie, in accordance with an embodiment of the present invention. The method 1500 is similar to method 500, with the exception of further steps based on a result of the polyploid phasing (of method 500 or step 1510 of method 1500). The method 1500 (as well as method 500) can be applied to input data relating to life sciences (e.g., SNPs, etc.) and/or to other types of inputs/signals as readily appreciated by one of ordinary skill in the art given the teachings of the present invention provided herein, while maintaining the spirit of the present invention. In the case of non-alleles, the input sources can be different persons (speech signals from different persons, etc.), different machines (stellar signals, data signals, electric fields, etc.), and so forth, as readily appreciated by one of ordinary skill in the art.

At step 1510, perform a phasing process using a trie (e.g., perform method 500 of FIG. 5). In an embodiment, the phasing process is an algebraic phasing process that uses a trie. In such algebraic phasing, rules are applied to an input matrix (e.g., matrix 200) and a trie (e.g., trie 300) to find the minimum number of homozygous parents for the input matrix. The goal of the phasing process is to determine the haplotype of the parent of the sample organisms in the input matrix.

At step 1520, perform an action responsive to the total number of haploids of any (or both) of the one or more sample organisms or a metric (haplotype) derived therefrom.

In an embodiment, step 1520 can include one or more of steps 1530A-F. Steps 1530A-E relate to life sciences, while step 1530F relates to signal disentanglement of any signal type including signals unrelated life sciences.

At step 1520A, perform a Genome wide association study. It an embodiment, the Genome wide association study can be used to determine if any gene variant is associated with a trait. In an embodiment, the Genome wide association study can involve identifying from which parent a haplotype has been inherited. Hence, in such a case, the present invention can provide a more fine-grained resolution output from a Genome wide association study than the prior art.

At step 1520B, perform pedigree identification. For example, haplotypes phasing in the examination of different individuals can be used to determine possible relationships and the pedigree of the sample in the data.

At step 1520C, impute missing values in a genetic marker for one of the sample organism based on information (e.g., results of the haplotype phasing) derived from or determined for the other sample organism. For example, using a correct phasing of a series of related individuals, it is possible to impute missing values in a genetic marker for a given one of the related individuals. This is often considered a fundamental task to properly analyze phenotype traits.

At step 1520D, perform a medical test by a hardware device based on the results of the haplotype phasing. For example, based on the results of the haplotype phasing, a medical test can be performed for disease diagnosis, and so forth. That is, based on the results of the haplotype phasing indicating that a sample organism has a particular trait relating to a condition with which a particular disease is often associated, a medical test for that particular disease can be performed to determine its existence in the sample organism or a related sample organism.

At step 1520E, perform a polymer chain disentanglement.

At step 1520F, perform a signal disentanglement between signals from different sources. The signal disentanglement can involve, but is not limited to, for example, voices in a crowd, stellar signals, electric fields, and so forth. In the case of step 430F, the input data would not a SNP.

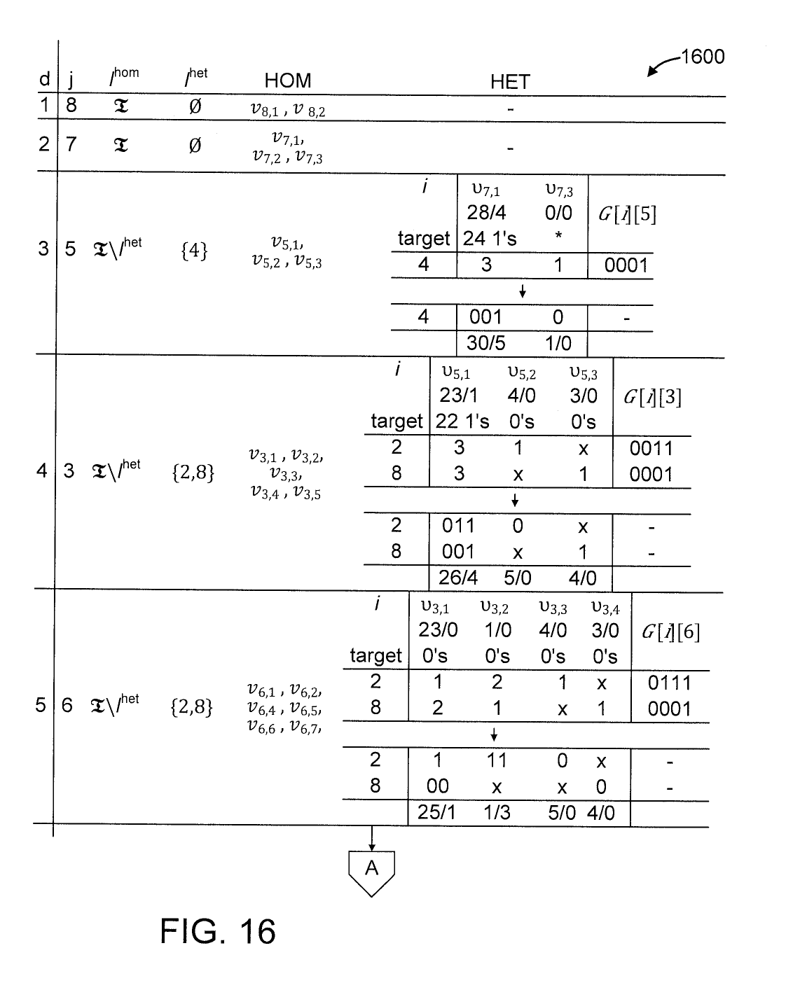

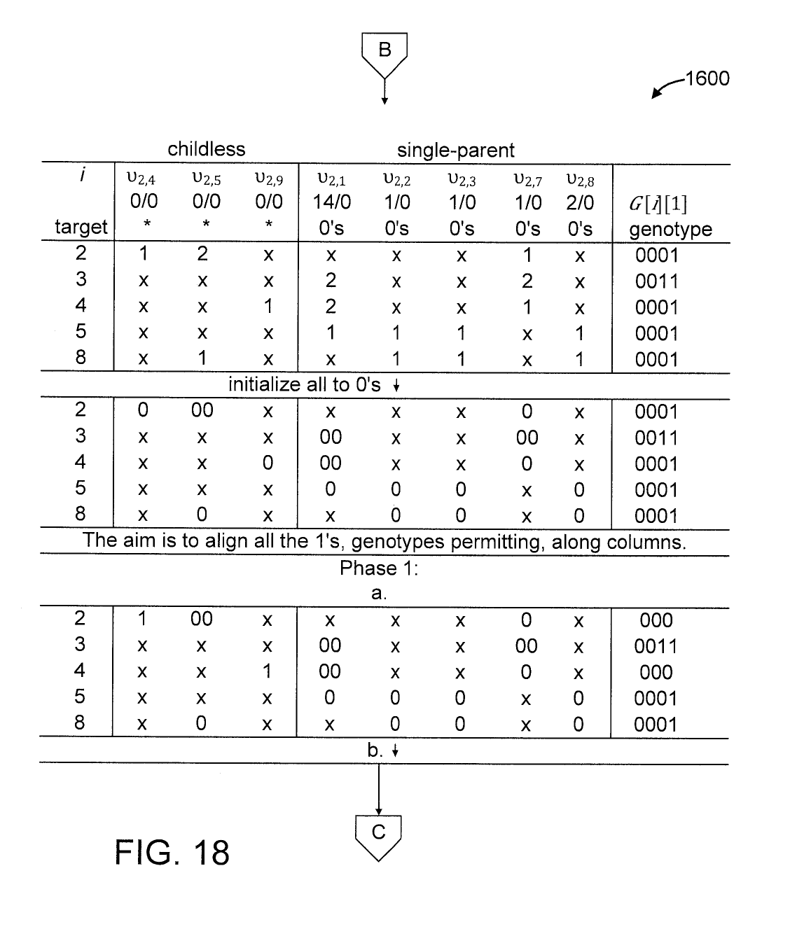

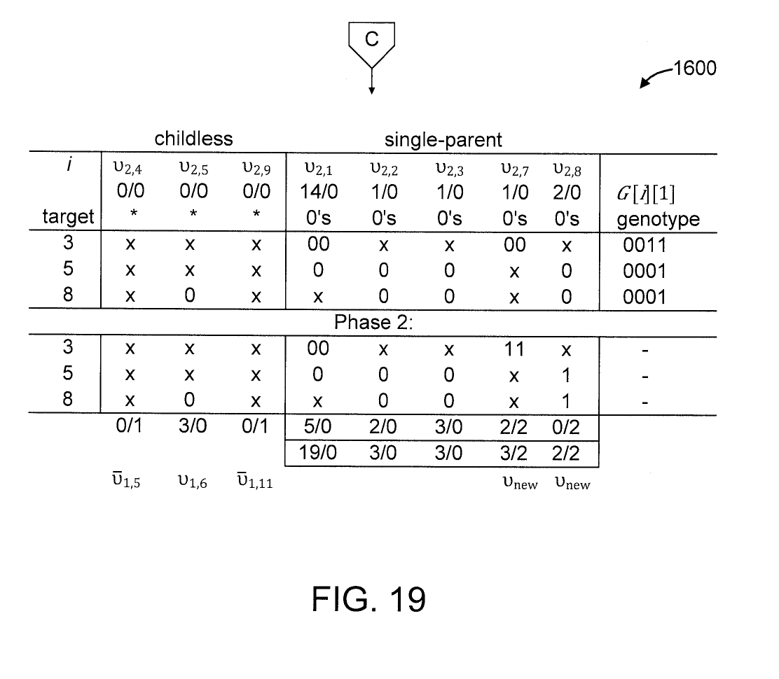

FIGS. 16-19 show an exemplary matrix 1600 for generating a trie, in accordance with an embodiment of the present invention. The matrix 1600 corresponds to step 550 of method 500 of FIG. 5.

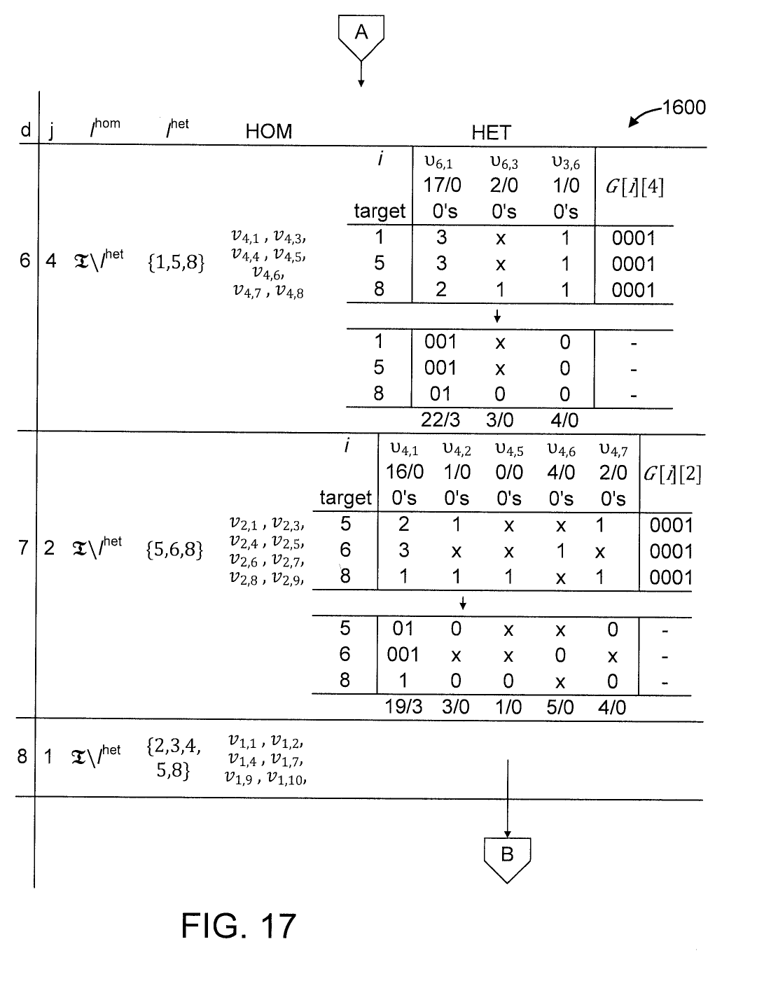

The matrix 1600 includes rows, each corresponding to a respective trie depth in a trie. In the example shown, d has a range of 1-8, with the rows for values of d spanning from 1-5 shown in FIG. 15, the rows for values of d spanning from 6-7 shown in FIG. 17, and the row for a value of d equal to 8 shown in FIGS. 17-19.

The matrix 1600 further includes columns for j, Iₕₒₘ, Iₕₑₜ, HOM, and HET.

The column for HET includes a respective sub-matrix for each depth value that, in turn, specifies i values denoting an i^{th} sample. The table is referred to as entry where the heuristics analyze the options for that set of nodes.

As applied to matrix 1600, step 550 of method 500 of FIG. 5 can be considered to include a phase 1 and a phase 2.

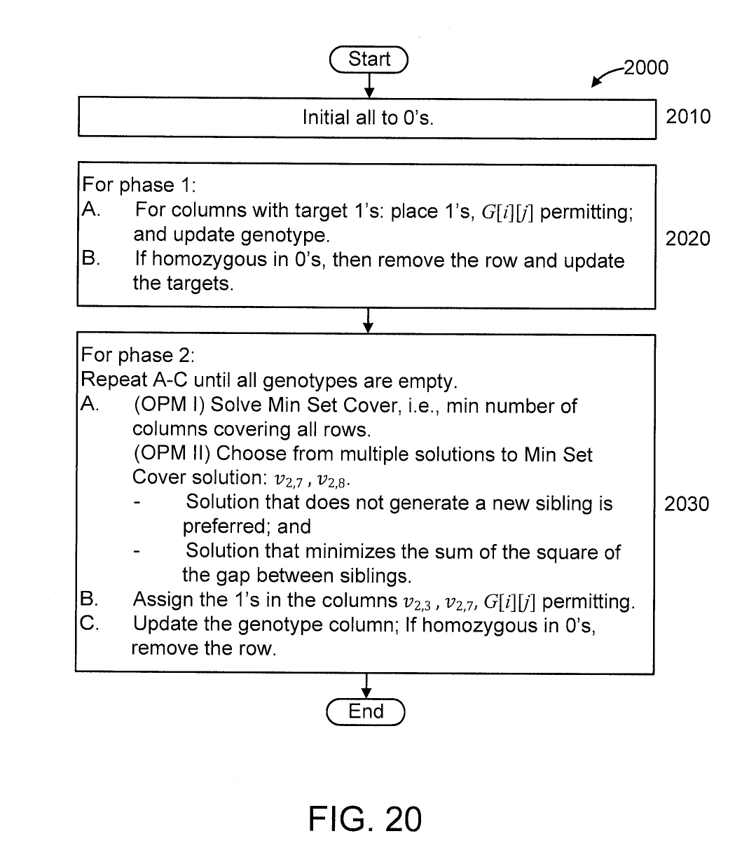

FIG. 20 shows an exemplary method 2000 for processing the matrix 1600 of FIGS. 16-19, in accordance with an embodiment of the present invention.

At step 210, prior to phase 1: initial all to 0's.

At step 220, corresponding to phase 1:

A. For columns with target 1's: place 1's, G[i][j] permitting; and update genotype.
B. If homozygous in 0's, then remove the row and update the targets.

At step 230, corresponding to phase 2:

Repeat A-C until all genotypes are empty.

A. (OPM I) Solve Min Set Cover, i.e., min number of columns covering all rows.

(OPM II) Choose from multiple solutions to Min Set Cover solution: v_{2,7}, v_{2,8}.
Solution that does not generate a new sibling is preferred; and
Solution that minimizes the sum of the square of the gap between siblings.
   B. Assign the 1's in the columns v_{2,7}, v_{2,8}, G[i][j] permitting.
   C. Update the genotype column; If homozygous in 0's, remove the row.

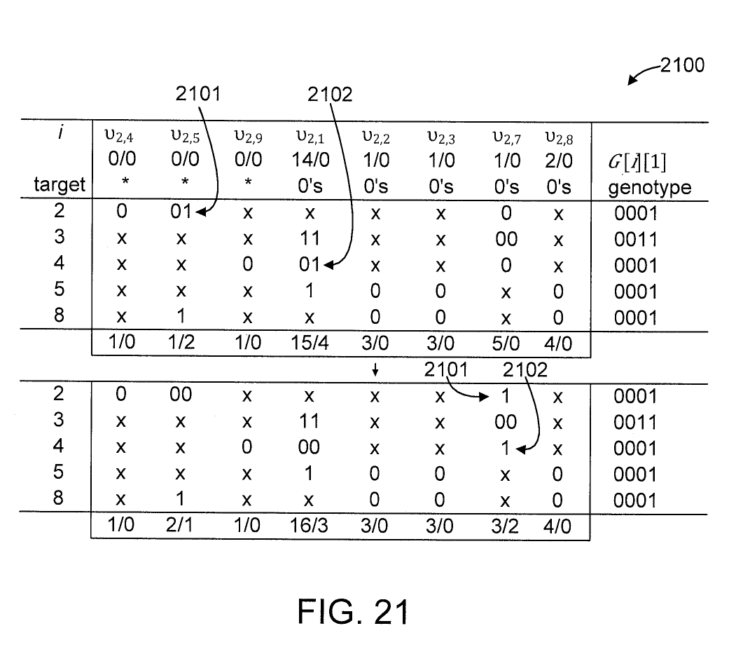

FIG. 21 shows an exemplary table 2100, in accordance with an embodiment of the present invention. At every depth/level of the trie, a table such as 2100 can be associated therewith that it is used to create the next step. In this table 2100, we are showing how the heuristics deal with such cases and create the level in the trie. The table 2100 includes haplotypes 2101 and haplotypes 2102.

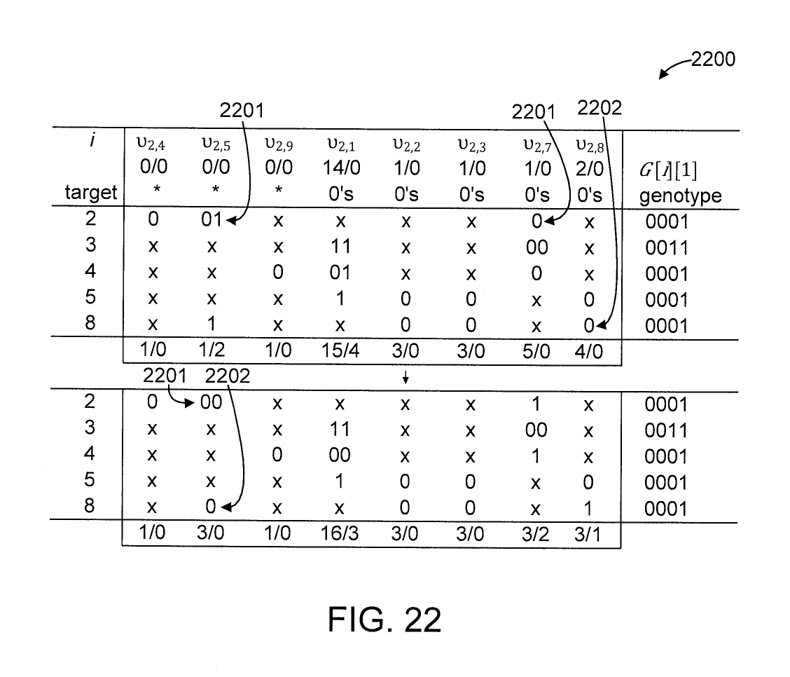

FIG. 22 shows another exemplary table 2200, in accordance with an embodiment of the present invention. At every depth/level of the trie, a table such as 2100 can be associated therewith that it is used to create the next step. In this table 2200, we are showing how the heuristics deal with such cases and create the level in the trie. The table 2200 includes haplotypes 2201 and haplotypes 2202.

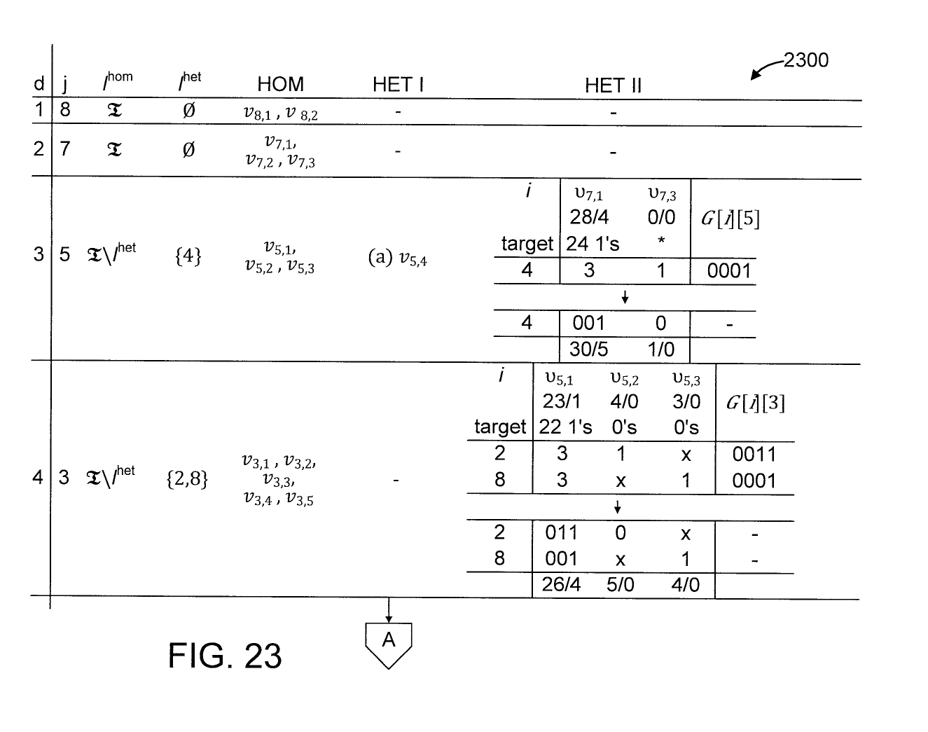

FIGS. 23-26 show another exemplary matrix 2300 for generating a trie, in accordance with an embodiment of the present invention. The matrix 2300 corresponds to step 550 of method 500 of FIG. 5, performed in a different manner than that involving matrix 1600 with respect to FIGS. 16-19.

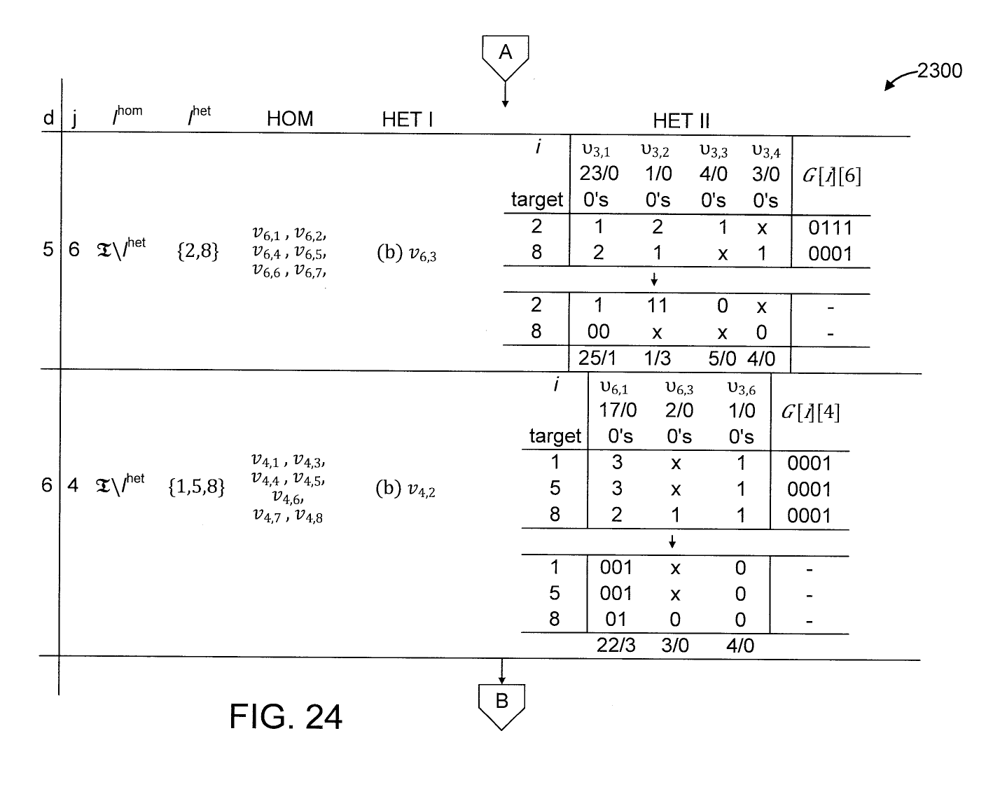

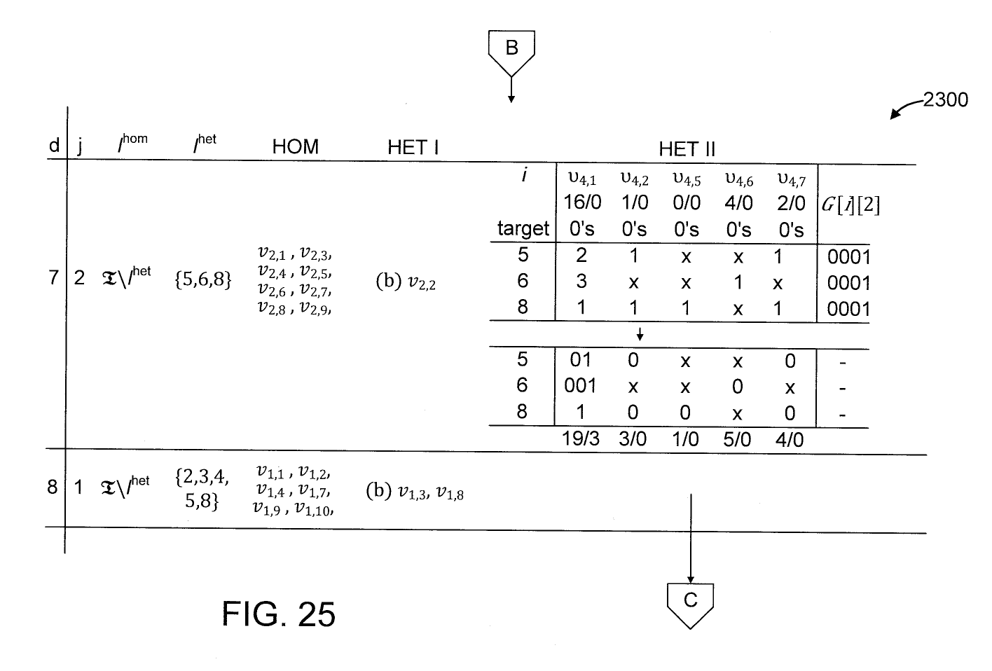

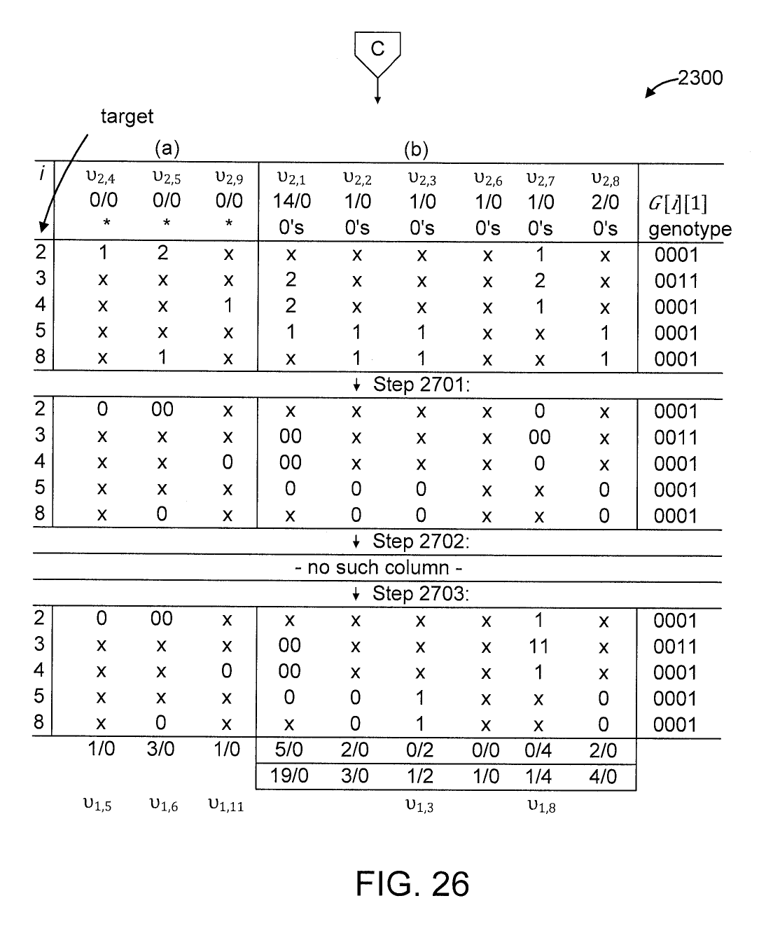

The matrix 2300 includes rows, each corresponding to a respective trie depth in a trie. In the example shown, d has a range of 1-8, with the rows for values of d spanning from 1-4 shown in FIG. 23, the rows for values of d spanning from 5-6 shown in FIG. 24, the row for a value of d equal to 7 shown in FIG. 25, and the row for a value of d equal to 8 shown in FIGS. 25-26.

The matrix 2300 further includes columns for j, Iₕₒₘ, Iₕₑₜ, HOM, HET I and HET II.

HET I or HET II are two different scenarios based on the configuration that handle the heterozygous case, HET I is when there is no choice, while HET II is using a more sophisticated approach (e.g., nodes and labels based on global optimization) when there are multiple choices (that is, AD II as referred to above).

As applied to matrix 2300, step 550 of method 500 of FIG. 5 can be considered to include a step 2701, a step 2702, and a step 2703.

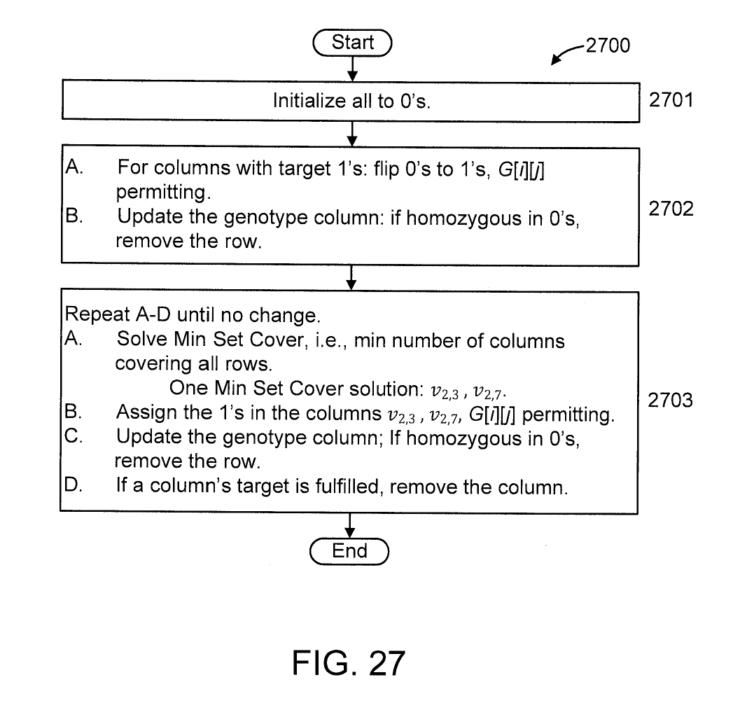

FIG. 27 shows an exemplary method 2700 for processing the matrix 2200 of FIGS. 23-26, in accordance with an embodiment of the present invention.

At step 2701, initialize all to 0's.

At step 2702:

A. For columns with target 1's: flip 0's to 1's, G[i][j] permitting.
B. Update the genotype column: if homozygous in 0's, remove the row.

In the example shown regarding FIG. 25, there is no such column.

At step 2703:

Repeat A-D until no change.

A. Solve Min Set Cover, i.e., min number of columns covering all rows.
One Min Set Cover solution: v_{2,3}, v_{2,7}.
   B. Assign the 1's in the columns v_{2,3}, v_{2,7}, G[i][j] permitting.
   C. Update the genotype column; If homozygous in 0's, remove the row.
   D. If a column's target is fulfilled, remove the column.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for phasing polyploids, comprising:
receiving, by a processor, a n×m matrix comprising a set of n rows and a set of m columns, each of the n rows representing a respective one of n samples, and each of the m columns representing a respective one of m SNPs for two or more sample organisms;
representing, by the processor, each allele in the m SNPs as a binary number; and
phasing, by the processor, the n samples to determine a haplotype of a parent of the two or more sample organisms,
wherein the phasing is performed using a trie to process a distribution of alleles in the n-samples that includes homozygous alleles and heterozygous alleles.

2. The computer-implemented method of claim 1, wherein the trie is formed based on a cost function configured to simultaneously maximize a number of haplotypes and a solution entropy.

3. The computer-implemented method of claim 1, wherein the solution entropy is calculated based on a haplotype occurrence frequency in the n samples.

4. The computer-implemented method of claim 1, wherein the trie is formed using an iterative method configured to prefer intermediate trie formation solutions that (i) avoid generating a new sibling node in the trie, and (ii) minimize a sum of a square of a gap between sibling nodes in the trie.

5. The computer-implemented method of claim 1, wherein the trie is formed to include a root node and plurality of nodes other than the root node, wherein each of the plurality of nodes are labeled with a respective label pair that includes a SNP label and a list label.

6. The computer-implemented method of claim 5, wherein the method further comprises implicitly representing, in the tree, respective cardinalities of the list labels for the plurality of nodes.

7. The computer-implemented method of claim 5, wherein the method further comprises implicitly representing, in the tree, the respective SNP labels for the plurality of nodes.

8. The computer-implemented method of claim 1, wherein the trie is formed such that each leaf node of the trie corresponds to a distinct haplotype that is obtainable from a label for the leaf node.

9. The computer-implemented method of claim 1, further comprising collapsing pairs of isomorphic sub-trees in the trie based at least on the pairs having identical allele values.

10. The computer-implemented method of claim 1, further comprising performing a trie shake optimization method on the trie that includes exchanging only branches of the trie that (i) are from a same one of the two or more sample organisms and (ii) have opposing labels at a same depth in the trie.

11. The computer-implemented method of claim 1, wherein Minor Allele Frequency (MAF) ones of the alleles are controlled along each of a plurality of paths in the trie.

12. The computer-implemented method of claim 1, wherein the trie is formed using a set cover based approach applied to the n×m matrix.

13. A computer program product for phasing polyploids, the computer program product comprising a non-transitory computer readable storage medium having program instructions embodied therewith, the program instructions executable by a computer to cause the computer to perform a method comprising:
receiving, by a processor, a n×m matrix comprising a set of n rows and a set of m columns, each of the n rows representing a respective one of n samples, and each of the m columns representing a respective one of m SNPs for two or more sample organisms;
representing, by the processor, each allele in the m SNPs as a binary number; and
phasing, by the processor, the n samples to determine a haplotype of a parent of the two or more sample organisms,
wherein the phasing is performed using a trie to process a distribution of alleles in the n-samples that includes homozygous alleles and heterozygous alleles.

14. The computer program product of claim 13, wherein the trie is formed using an iterative method configured to prefer intermediate trie formation solutions that (i) avoid generating a new sibling node in the trie, and (ii) minimize a sum of a square of a gap between sibling nodes in the trie.

15. The computer program product of claim 13, wherein the trie is formed such that each leaf node of the trie corresponds to a distinct haplotype that is obtainable from a label for the leaf node.

16. The computer program product of claim 13, further comprising collapsing pairs of isomorphic sub-trees in the trie based at least on the pairs having identical allele values.

17. The computer program product of claim 13, further comprising performing a trie shake optimization method on the trie that includes exchanging only branches of the trie that (i) are from a same one of the two or more sample organisms and (ii) have opposing labels at a same depth in the trie.

18. The computer program product of claim 13, wherein Minor Allele Frequency (MAF) ones of the alleles are controlled along each of a plurality of paths in the trie.

19. The computer program product of claim 13, wherein the trie is formed using a set cover based approach applied to the n×m matrix.

20. A computer processing system for phasing polyploids, comprising:
a processor, configured to
receive a n×m matrix comprising a set of n rows and a set of m columns, each of the n rows representing a respective one of n samples, and each of the m columns representing a respective one of m SNPs for two or more sample organisms;
represent each allele in the m SNPs as a binary number; and
phase the n samples to determine a haplotype of a parent of the two or more sample organisms,
wherein the n samples are phased using a trie to process a distribution of alleles in the n-samples that includes homozygous alleles and heterozygous alleles.
